(19) United States
(12) Patent Application Publication
(10) Pub. No.: US 2016/0002363 A1
(43) Pub. Date: Jan. 7, 2016

(54) Process For Filtration Of Homopolysaccharides

(71) Applicant: WINTERSHALL HOLDING GMBH, Kassel (DE)

(72) Inventors: Jörg Therre, Worms (DE); Hartwig Voß, Frankenthal (DE); Tobias Käppler, Maxdorf (DE); Sascha Rollie, Mannheim (DE); Stephan Freyer, Neustadt (DE); Bernd Leonhardt, Kassel (DE)

(21) Appl. No.: 14/772,230

(22) PCT Filed: Feb. 26, 2014
(86) PCT No.: PCT/EP2014/053747

§ 371 Date: Sep. 2, 2015

Related U.S. Application Data
(60) Provisional application No. 61/772,569, filed on Mar. 5, 2013.

(30) Foreign Application Priority Data
Mar. 5, 2013 (EP) 13157826.2

(51) Int. Cl. C08B 37/00; B01D 69/04; B01D 61/14

(52) U.S. Cl. CPC C08B 37/0024; C08B 37/0003; B01D 61/147; B01D 69/043

(57) ABSTRACT

The present invention relates to an improved process for filtering aqueous fermentation broths comprising glucans and biomass using symmetrical tubular membranes.

The present invention relates to an improved process for filtering aqueous fermentation broths comprising glucans and biomass using symmetrical tubular membranes.

In natural occurrences of petroleum, petroleum is present in the voids of porous storage rocks which are covered to the earth's surface by impermeable covering layers. The voids can be very fine voids, capillaries, pores or the like. Fine pore necks can have, for example, a diameter of only about 1 μm. Apart from petroleum, including proportions of natural gas, a reservoir comprises more or less strongly salt-comprising water.

In petroleum recovery, a distinction is made between primary, secondary and tertiary recovery. In primary recovery, the petroleum flows spontaneously under the reservoir's own pressure through the well to the surface after drilling down to the reservoir. Depending on the reservoir type, it is usually only possible to recover from about 5 to 10% of the amount of petroleum present in the reservoir by means of primary recovery; then, the intrinsic pressure is no longer sufficient for recovery. In secondary recovery, the pressure in the reservoir is maintained by injection of water and/or steam, but the petroleum cannot be fully recovered even by means of this technique. Tertiary petroleum recovery encompasses processes in which suitable chemicals are used as auxiliaries for petroleum recovery. These include “polymer flooding”. In polymer flooding, an aqueous solution of a thickening polymer is injected instead of water into the petroleum reservoir via the injection wells. This enables the yield to be increased further compared to the use of water or steam.

Many different water-soluble polymers, both synthetic polymers such as polyacrylamides or copolymers comprising acrylamide and other monomers and also water-soluble polymers of natural origin, have been proposed for polymer flooding.

An important class of polymers of natural origin for polymer flooding is formed by branched homopolysaccharides derived from glucose. Polysaccharides composed of glucose units are also known as glucans. The branched homopolysaccharides mentioned have a main chain composed of β-1,3-linked glucose units of which, statistically, about each third unit is β-1,6-glycosidically linked to a further glucose unit. Aqueous solutions of such branched homopolysaccharides have advantageous physicochemical properties, so that they are particularly well suited to polymer flooding.

Homopolysaccharides having the structure mentioned are secreted by various strains of fungi, for example by the basidiomycete Schizophyllum commune which grows as filaments and during growth secretes a homopolysaccharide of the abovementioned structure having a typical molecular weight Mw of from about 2 to about 25*10⁶ g/mol (trivial name: schizophyllan). Mention may also be made of homopolysaccharides of the abovementioned structure secreted by Sclerotium rolfsii (trivial name: scleroglucans).

Processes for producing branched homopolysaccharides composed of β-1,3-linked glucose units by fermentation of strains of fungi and subsequent filtration of the fermentation broth are known. However, the limiting factor for an industrial process for production of homopolysaccharides by fermentation has hitherto been the necessity of filtering large amounts of fermentation broth. It is known that above even low concentrations of 8 g/l, glucans form highly viscose gels which can be handled only with difficulty in the industry. The great demand for glucan can therefore not be satisfied by obtaining a higher concentration of glucan during the fermentation. Instead, it is necessary to increase the amount of fermentation broth itself. This makes it necessary to filter large amounts of fermentation broth. However, the filtration processes known hitherto are not suitable for filtering large amounts of fermentation broth since they can be operated at an average flux of only 10 kg/h/m² or less during the filtration.

EP 271 907 A2 and EP 504 673 A1 disclose processes and strains of fungi for producing branched homopolysaccharides composed of β-1,3-linked glucose units. Production is carried out by batchwise fermentation of the strains with stirring and aeration. The nutrient medium consists essentially of glucose, yeast extract, potassium dihydrogenphosphate, magnesium sulfate and water. The polymer is secreted by the fungus into the aqueous fermentation broth and an aqueous polymer solution is finally separated off from the biomass-comprising fermentation broth, for example by centrifugation or filtration.

“Udo Rau, “Biosynthese, Produktion and Eigenschaften von extrazellulären Pilz-Glucanen”, Habilitationsschrift, Technical University of Braunschweig, 1997, pages 70 to 95”, describes the production of schizophyllan by continuous or discontinuous fermentation, in which the isolation of the schizophyllan can be effected by means of crossflow filtration. (loc. cit., page 75). Various stainless steel membranes having pore openings of 0.5 μm, 2 μm, 10 μm and 20 μm were tested for separating off the cell mass.

“Udo Rau, “Biopolymers”, edited by A. Steinbüchel, Volume 6, pages 63 to 79, WILEY-VCH publishers, New York, 2002”, describes the production of schizophyllan by continuous or discontinuous fermentation. Centrifugation and crossflow microfiltration are recommended for isolating the cell-free and cell fragment-free schizophyllan (loc. cit., page 78, paragraph 10.1). The use of sintered stainless steel membranes having a pore size of 10 μm from Krebsoege (now GKN) is proposed there for the crossflow microfiltration.

WO 2003/016545 A2 discloses a continuous process for producing scleroglucans using Sclerotium rolfsii. For purification, a crossflow filtration using stainless steel filters having a pore size of 20 μm at a flow velocity over the filter of at least 7 m/s is described.

WO 2011/082973 A2 describes the removal of cells by means of asymmetric membranes in which the pore size of the separation layer is from 1 μm to 10 μm. It is possible to use flat membranes or asymmetrical tubular membranes, single-channel modules or multichannel modules.

In Haarstrick et al. (Bioprocess. Engineering 6 (1991) 179-186), a ceramic tubular membrane “PSK CER from Millipore” having a pore size of from 0.45 μm to 1.0 μm is used for separating off cells. These tubular membranes are not suitable for separating schizophyllan off from fermentation broths since the pore size is too small to allow schizophyllan to pass through the pores.

In Chem.-Ing.-Tech. 63 (1991), No. 7, page A468, the use of flat stainless steel woven membranes is recommended for separating off hypha fragments from high molecular weight polymer solutions.

In Haarstrick (“Mechanische Trennverfahren zur Gewinnung zellfreier, hochviskoser Polysaccharidlosungen von Schizophyllum commune ATCC 38548”, thesis, Technical University of Braunschweig, 1992), a woven stainless steel mesh having a nominal pore size of 0.5 μm, 2 μm, 10 μm, 100 μm and 200 μm, an internal diameter of 8 mm and a channel length of 300 mm is used for separating off cells (pages 10 and 63).

In Journal of Membrane Science 117 (1996), pages 237 to 249 the ultrafiltration of xanthan from a fermentation broth is described.

GIT Fachzeitung Labor (12/92, pages 1233-1238) describes continuous production of branched glucans with cell recirculation. This arrangement is also referred to in the literature as membrane bioreactor having an external membrane stage. To separate off the branched glucans from the fermentation circuit, a crossflow filtration by means of stainless steel membranes having a pore size of 200 μm is proposed. As a further method for the second purification stage, the authors have examined crossflow filtration over ceramic membranes without success. As a result of their experiments, they draw the conclusion that crossflow microfiltration is not suitable for the separation of cells from hypha-comprising, highly viscous culture suspensions.

The processes described in the prior art for separating glucans from fermentation broths cannot be operated economically on an industrial scale.

There is therefore a need for a process for separating glucans from fermentation broths comprising biomass and glucans, in which a fermentation broth is passed at a high average flow velocity through symmetrical tubular membranes, without the quality of the aqueous solution of glucan obtained being adversely affected, for example in the form of a higher content of cell fragments.

A high average flux indicates that the process for separating glucans from fermentation broths comprising biomass and glucan can be operated at a pumped throughput which allows the process to be economical.

The abovementioned object is achieved by provision of a process for separating off an aqueous solution of glucans from an aqueous fermentation broth comprising glucans and biomass in a filtration plant using symmetrical tubular membranes which have a cylindrical shape and an internal diameter in the range from ≧2 mm to ≦6 mm.

The present invention therefore provides, in one embodiment, a process for separating off an aqueous solution of glucans from an aqueous fermentation broth comprising glucans and biomass in a filtration plant, which comprises at least the following steps
a) introducing a feed stream comprising the aqueous fermentation broth into the filtration plant,
b) passing the feed stream through at least one tubular membrane which has a cylindrical shape and has pores,
c) taking off a permeate stream comprising the aqueous solutions of glucans,
   wherein the tubular membrane has an internal diameter in the range from ≧2 mm to ≦6 mm.

The present invention therefore provides, in a further embodiment, a process for separating off an aqueous solution of glucans from an aqueous fermentation broth comprising glucans and biomass in a filtration plant, which comprises at least the following steps
a) introducing a feed stream comprising the aqueous fermentation broth into the filtration plant,
b) passing the feed stream through at least one symmetrical tubular membrane which has a cylindrical shape and has pores,
c) taking off a permeate stream comprising the aqueous solution of glucans, wherein the symmetrical tubular membrane has an internal diameter in the range from ≧2 mm to ≦6 mm.

The present invention therefore provides, in a further embodiment, a process for separating off an aqueous solution of glucans from an aqueous fermentation broth comprising glucans and biomass in a filtration plant, which comprises at least the following steps
a) introducing a feed stream comprising the aqueous fermentation broth into the filtration plant,
b) passing the feed stream through at least one symmetrical tubular membrane which has a cylindrical shape and has pores,
c) taking off a permeate stream comprising the aqueous solution of glucans, wherein the symmetrical tubular membrane has an internal diameter in the range from ≧2 mm to ≦6 mm and a separation limit in the range from ≧0.5 to ≦45 μm, determined in accordance with ASTM F 795.

The use of tubular membranes, preferably symmetrical tubular membranes, which possess pores and have an internal diameter in the range from ≧2 mm to ≦6 mm makes it possible to carry out the separation of the glucans from the fermentation broth economically since only a membrane area of from 10 to 15 m² is required for obtaining 1 t of glucan solution per hour.

For the purposes of the present invention, symmetrical tubular membranes are tubular membranes which have a pore distribution which is essentially constant over the entire cross section of the membrane wall. Symmetrical tubular membranes are known to those skilled in the art and are described, inter alia, in T. Melin and R. Rautenbach, Membranverfahren (Grundlagen der Modul- and Anlagenauslegung), 3^{rd} edition (2007), Springer Verlag, page 20 ff.

A symmetrical tubular membrane which has a cylindrical shape is a tubular membrane which extends along a longitudinal axis and has a hollow space which is surrounded by walls and can have either an essentially polygonal cross section or a round, i.e. circular or oval, cross section.

### TABLE OF FIGURES

FIG. 1 Depiction of a tubular membrane

FIG. 2 Schematic depiction of a filtration plant

FIG. 3 Depiction of a membrane element having a hexagonal shaped body

FIG. 4 Schematic depiction of a filtration plant

Glucans are a class of homopolysaccharides whose monomer building block is exclusively glucose. The glucose molecule can be α-glycosidically or β-glycosidically linked, branched to varying degrees or be linear. Preference is given to glucans selected from the group consisting of cellulose, amylose, dextran, glycogen, lichenin, laminarin from algae, pachyman from tree fungi and yeast glucans having β-1,3-bonding; nigeran, a mycodextran isolated from fungi (α-1,3-glucan, α-1,4-glucan), curdlan (β-1,3-D-glucan), pullulan (α-1,4-bonded and α-1,6-bonded D-glucan) and schizophyllan (β-1,3-main chain, β-1,6-side chain) and pustulan (β-1,6-glucan).

The glucan preferably comprises a main chain composed of β-1,3-glycosidically linked glucose units and side groups which are composed of glucose units and are β-1,6-glycosidically bound to the main chain. The side groups preferably consist of a single β-1,6-glycosidically bound glucose unit, with, statistically, each third unit of the main chain being β-1,6-glycosidically linked to a further glucose unit.

Schizophyllan has a structure corresponding to the formula (I), where n is in the range from 2500 to 35 000.

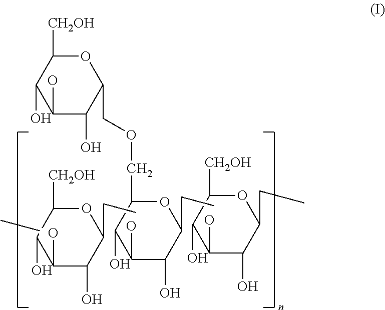

Such glucan-secreting strains of fungi are known to those skilled in the art. The strains of fungi are preferably selected from the group consisting of Schizophyllum commune, Sclerotium rolfsg Sclerotium glucanicum, Mondinla fructigena, Lentinula edodes and Botrytis cinera. Suitable strains of fungi are also mentioned, for example, in EP 271 907 A2 and EP 504 673 A1, in each case claim 1. The strain of fungus used is particularly preferably Schizophyllum commune or Sclerotium rolfsii and very particularly preferably Schizophyllum commune. This strain of fungus secretes a glucan in which, on a main chain composed of β-1,3-glycosidically linked glucose units, each third unit, statistically, of the main chain is β-1,6-glycosidically linked to a further glucose unit; i.e. the glucan is preferably schizophyllan.

Typical schizophyllans have a weight average molecular weight Mw of from about 2 to about 25-10⁶ g/mol.

The strains of fungi are fermented in a suitable aqueous medium or nutrient medium. During the course of the fermentation, the fungi secrete the abovementioned class of glucans into the aqueous medium.

Processes for the fermentation of the abovementioned strains of fungi are known in principle to those skilled in the art, for example from EP 271 907 A2, EP 504 673 A1, DE 40 12 238 A1, WO 03/016545 A2 and also “Udo Rau, “Biosynthese, Produktion und Eigenschaften von extrazellulären Pilz-Glucanen”, Habilitationsschrift, Technical University of Braunschweig, 1997”. These documents in each case also describe suitable aqueous media or nutrient media.

The fermentation broth is obtained by fermenting fungi in a suitable aqueous nutrient medium. During the course of the fermentation, the fungi secrete the abovementioned class of glucans into the aqueous fermentation broth.

Processes for the fermentation of such strains of fungi are known in principle to those skilled in the art, for example from EP 271 907 A2, EP 504 673 A1, DE 40 12 238 A1, WO 2003/016545 A2 and also “Udo Rau, “Biosynthese, Produktion und Eigenschaften von extrazellulären Pilz-Glucanen”, Habilitationsschrift, Technical University of Braunschweig, 1997”, which in each case also mention suitable nutrient media.

The fungi can preferably be cultivated, for example, in an aqueous nutrient medium at a temperature of from 15° C. to 40° C., preferably from 25° C. to 30° C., preferably with aeration and agitation, for example by means of a stirrer.

The fermentation is preferably carried out in such a way that the concentration of the target glucans in the fermentation broth to be filtered is at least 8 g/l. The upper limit is in principle not restricted. It is determined by the viscosity at which the fermentation apparatus used in each case can still be managed.

Finally, an aqueous solution comprising glucans is separated off from the fermentation broth comprising dissolved glucans and also biomass (fungal cells and possibly cell constituents) by crossflow microfiltration according to the process of the invention, leaving an aqueous fermentation broth in which the biomass has a higher concentration than before.

In a further embodiment of the invention, the fermentation is carried out in a suitable plant comprising at least one fermentation vessel. Fermentation broth is taken off continually or from time to time from the plant via a side stream and an aqueous solution comprising glucans is separated off therefrom by crossflow microfiltration according to the process of the invention. The remaining aqueous fermentation broth, in which the biomass has a higher concentration than before, also referred to as retentate stream, can be at least partly recirculated to the fermentation vessel.

In a particularly preferred embodiment, the present invention provides a process for separating off an aqueous solution of glucans which comprise a main chain made up of β-1,3-glycosidically linked glucose units and side groups which are β-1,6-glycosidically bound thereto and are composed of glucose units from an aqueous fermentation broth comprising glucans which comprise a main chain composed of β-1,3-glycosidically linked glucose units and side chains which are β-1,6-glyclosidically bound thereto and are composed of glucose units and biomass in a filtration plant, which comprises at least the following steps
a) introducing a feed stream comprising the aqueous fermentation broth into the filtration plant,
b) passing the feed stream through at least one symmetrical tubular membrane which has a cylindrical shape and has pores,
c) taking off a permeate stream comprising the aqueous solution of glucans which comprise a main chain composed of β-1,3-glycosidically linked glucose units and side groups which are β-1,6-glyclosidically bound thereto and are composed of glucose units,
   wherein the symmetrical tubular membrane has an internal diameter in the range from ≧2 mm to ≦6 mm.

In a very particularly preferred embodiment, the present invention provides a process for separating off an aqueous solution of glucans which comprise a main chain composed of β-1,3-glycosidically linked glucose units and side groups which are β-1,6-glyclosidically bound thereto and are composed of glucose units from an aqueous fermentation broth comprising glucans which comprise a main chain composed of β-1,3-glycosidically linked glucose units and side groups which are β-1,6-glyclosidically bound thereto and are composed of glucose units and biomass in a filtration plant, which comprises at least the following steps
a) introducing a feed stream comprising the aqueous fermentation broth into the filtration plant,
b) passing the feed stream through at least one symmetrical tubular membrane which has a cylindrical shape and has pores,
c) taking off a permeate stream comprising the aqueous solution of glucans which comprise a main chain composed of β-1,3-glycosidically linked glucose units and side groups which are β-1,6-glyclosidically linked thereto and are composed of glucose units,
   wherein the symmetrical tubular membrane has an internal diameter in the range from ≧2 mm to ≦6 mm and a separation limit in the range from ≧0.5 to ≦45 μm, determined in accordance with ASTM F 795.

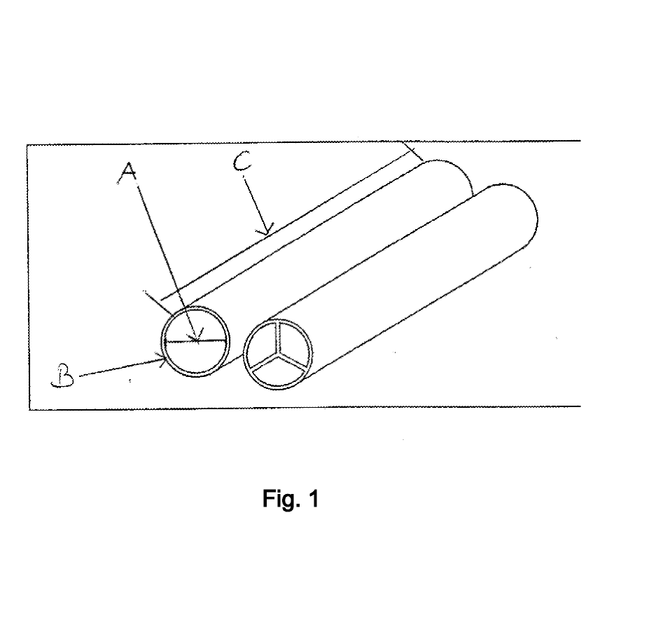

The tubular membrane, preferably the symmetrical tubular membrane, preferably has an internal diameter, as indicated by the dimension A in FIG. 1, in the range from ≧3 mm to ≦6 mm, particularly preferably in the range from ≧2 mm to ≦5 mm, and very particularly preferably in the range from ≧2 mm to ≦4 mm.

The tubular membrane, preferably the symmetrical tubular membranes, preferably has pores having a d90 pore size in the range from ≧4 μm to ≦45 μm, the tubular membrane, preferably the symmetrical tubular membrane, particularly preferably has pores having a d90 pore size in the range from ≧4 μm to ≦20 μm and the tubular membrane, preferably the symmetrical tubular membrane, particularly preferably has pores having a d90 pore size in the range from ≧4 μm to ≦9 μm, in each case determined in accordance with ISO 15901-1. The term “d90 pore size” is known to those skilled in the art. It is determined from a pore size distribution curve of the support material, where the “d90 pore size” refers to the pore size at which 90% of the pore volume of the material has a pore size 5 d90 pore size. The pore size distribution of a material can, for example, be determined by means of mercury porosimetry and/or gas adsorption methods.

The tubular membrane, preferably the symmetrical tubular membrane, is preferably made of a material which has a separation limit in the range from ≧0.5 to ≦45 μm, particularly preferably in the range from ≧1.0 to ≦10 μm, very particularly preferably in the range from ≧1.0 to ≦6.0 μm, and in particular in the range from ≧1.0 to ≦5.0 μm, determined in each case in accordance with ASTM F 795.

The tubular membrane, preferably the symmetrical tubular membrane, preferably has a length, as indicated by the dimension C in FIG. 1, in the range from ≧0.2 m to ≦1.5 m, particularly preferably in the range from ≧0.2 m to ≦1.2 m, very particularly preferably in the range from ≧0.3 m to ≦1.0 m and even more preferably in the range from ≧0.3 m to ≦0.7 m.

The tubular membrane, preferably the symmetrical tubular membrane, preferably has a wall thickness, as indicated by the dimension B in FIG. 1, in the range from ≧0.3 mm to ≦3.0 mm, particularly preferably in the range from ≧1.0 mm to ≦2.0 mm. It is advantageous for a tubular membrane having a very low wall thickness to be selected, since this configuration makes it possible to achieve a higher average flux compared to a tubular membrane having the same external diameter and a higher wall thickness.

The tubular membrane, preferably the symmetrical tubular membrane, preferably has a fluid permeability a in the range from 0.15·10⁻¹² m² to 1.80·10⁻¹² m² in accordance with DIN ISO 4022. The tubular membrane, preferably the symmetrical tubular membrane, likewise preferably has a fluid permeability coefficient β in the range from 0.06·10⁻¹² m² to 1.7·10⁻¹² m² in accordance with DIN ISO 4022.

The tubular membranes used according to the invention are preferably symmetrical.

The tubular membranes, preferably the symmetrical tubular membranes, can preferably be metallic tubular membranes or ceramic tubular membranes. The tubular membranes used, preferably the symmetrical tubular membranes used, are preferably sintered metal tubular membranes, preferably symmetrical sintered metal tubular membranes. The sintered metal tubular membranes, preferably the symmetrical sintered metal tubular membranes, preferably consist of a material selected from the group consisting of stainless steel, titanium, nickel-copper alloy, nickel-chromium alloy, nickel-iron alloy, nickel-iron-chromium alloy, bronze and zirconium. These tubular membranes can be obtained, for example, from GKN Sinter Metals Filters GmbH, Radevormwald, Germany. The cross section of the tubular membrane, preferably of the symmetrical tubular membrane, is preferably round (i.e. circular or oval) or polygonal, for example quadrilateral or hexagonal. The cross section of the tubular membrane, preferably of the symmetrical tubular membrane, is particularly preferably round.

The tubular membranes, preferably the symmetrical tubular membranes, are preferably used as monochannel elements.

The at least one tubular membrane, preferably the at least one symmetrical tubular membrane, preferably forms, together with from 2 to 15 000 further tubular membranes which are arranged parallel to the at least one tubular membrane, preferably the at least one symmetrical tubular membrane, a membrane module.

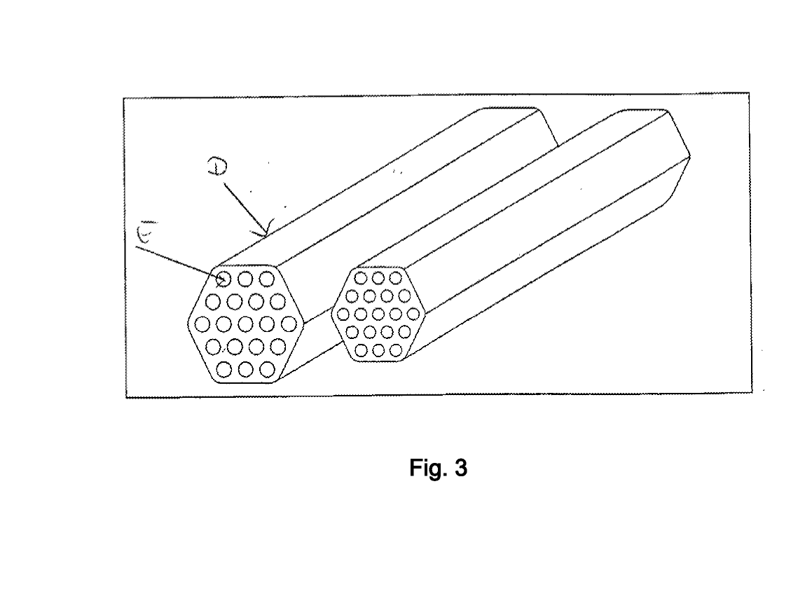

The tubular membranes, preferably the symmetrical tubular membranes, can also be used as multichannel elements. In the case of multichannel elements, the support material forms a shaped body, for example a round or hexagonal shaped body, as indicated by the symbol D in FIG. 3, into which channels, as indicated by the symbol E in FIG. 3, are let. The external diameter of such a shaped body for a membrane module is preferably from 5 mm to 100 mm, particularly preferably from 10 mm to 50 mm. The multichannel elements offer the advantage of a larger membrane surface for the same space requirement and simpler assembly. A disadvantage is the more difficult manufacture of the multichannel elements compared to the single-channel elements.

A plurality of membrane modules can be arranged in parallel or in series. Preference is given to 2, 3, 4, 5, 6, 7, 8, 9 or 10, particularly preferably 3, 4, 5 or 5, membrane modules being arranged in series.

In crossflow filtration, a stream of the liquid to be filtered is, for example by means of a suitable circulation pump, conveyed parallel to the surface of the membrane used as filtration material. A liquid stream thus flows continually over the filter membrane, thus preventing or at least reducing the formation of deposits on the membrane surface. All types of pump are in principle suitable as pump. However, owing to the high viscosity of the fermentation broth, displacement pumps have been found to be particularly useful and eccentric screw pumps and rotary piston pumps have been found to be very particularly useful. Centrifugal pumps, channel wheel pumps and Pitot pumps have likewise been found to be suitable.

To carry out the process of the invention, the tubular membranes according to the invention are installed in suitable filter plants. Constructions of suitable filter plants are known in principle to those skilled in the art.

Tubular membranes, preferably symmetrical tubular membranes, are used for carrying out the process of the invention. In the case of tubular membranes, the retentate is preferably conveyed through the interior of the channel or channels and the permeate correspondingly migrates outward through the walls of the support material into the permeate space. It is less preferred for retentate to be present outside the channel or channels and the permeate to collect in the interior of the channel or channels.

The feed stream is preferably conveyed, in step b), at a flow velocity over the membrane in the range from ≧0.5 m/s to ≦5 m/s, particularly preferably in the range from ≧2 m/s to ≦4 m/s. A flow velocity over the membrane which is too low is unfavorable since the membrane then quickly becomes blocked, while a flow velocity which is too high incurs unnecessarily high costs because of the large amount of retentate to be circulated.

The temperature at which the feed stream is passed through the at least one tubular membrane, preferably the at least one symmetrical tubular membrane, is not critical and is preferably in the range from 5° C. to 150° C., particularly preferably from 10° C. to 80° C. and very particularly preferably from 15° C. to 40° C. If the cells which are separated off are not to be killed, i.e. for example in the case of processes with recirculation of the biomass, the temperature should be in the range from 15° C. to 40° C.

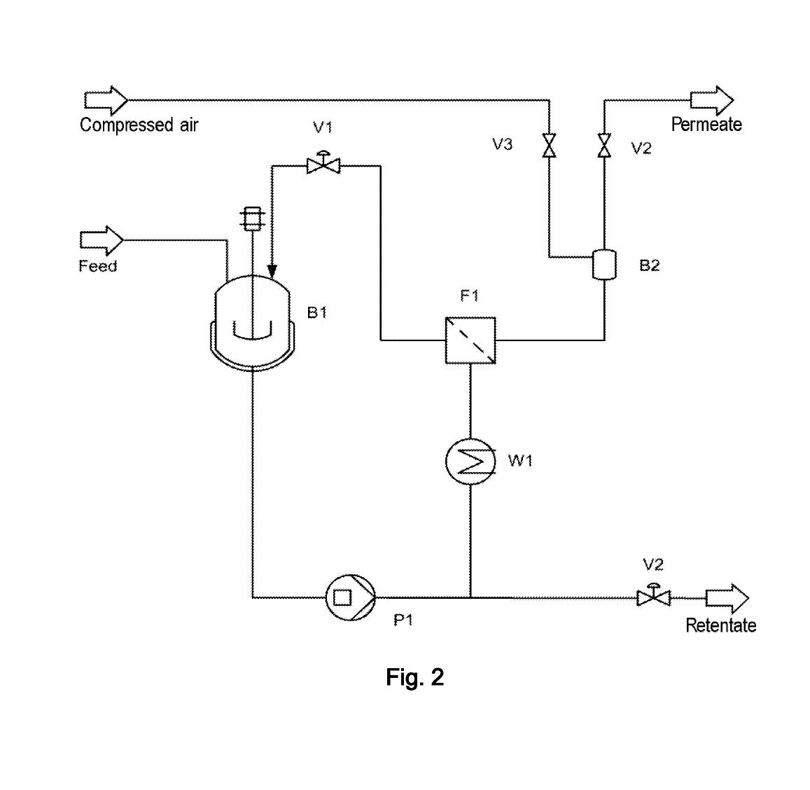

A preferred embodiment of a filtration plant to be used according to the invention is shown in FIG. 2. The preferred apparatus comprises a circulation pump P1, a filter module F1 and a heat exchanger W1. The abovementioned crossflow of the liquid over the surface of the tubular membrane arranged in the filter apparatus F1 is generated by means of the pump P1. The temperature of the contents of the plant can be controlled by means of a heat exchanger W1. A plurality of such filtration plants can be connected in series or in parallel.

The filter apparatus F1 comprises a housing in which at least one tubular membrane is installed. The tubular membrane separates the housing into a retentate space and a permeate space. The liquid coming from the pump P1, referred to as feed, is the fermentation broth comprising biomass and glucan. The feed goes via at least one inlet into the retentate space. A liquid stream, referred to as concentrate, leaves the retentate space again through at least one outlet. The pressure in the retentate space is greater than the pressure in the permeate space. The pressure difference is referred to as the transmembrane pressure. Part of the feed stream passes through the membrane and collects in the permeate space. This part of the liquid which passes through, referred to as permeate, represents the glucan solution which has been separated from biomass. The introduction of the feed stream in step a) and the taking-off of the permeate stream in step c) are preferably carried out continuously, with the continuous taking-off of the permeate stream being able to be interrupted by regular backflushing operations. The taking-off of the permeate stream and the introduction of the retentate stream are preferably carried out continuously, with the ratio of the amount of permeate stream to the amount of the retentate stream preferably being in the range from 0.5 to 20.

The transmembrane pressure is preferably from 0.1 bar to 10 bar, particularly preferably from 0.5 bar to 6 bar and very particularly preferably from 1 bar to 4 bar. The transmembrane pressure is preferably set by bringing the transmembrane pressure to the desired value by means of a ramp having a gradient of preferably from 0.05 bar/h to 2 bar/h.

The time of operation of the membrane filtration plant can optionally be extended by regular backflushing with permeate. For this purpose, a pressure which is greater than the pressure in the retentate space is applied at regular intervals to the permeate space and a particular amount of permeate is pushed backward through the membrane into the retentate space for a defined time. This backflushing can, for example, be effected by pressurizing the permeate space with nitrogen, by means of a backflushing pump or by use of a piston system as is marketed, for example, under the name “BACKPULSE DECOLMATEUR BF 100” by Pall, Bad Kreuznach. Backflushing should be carried out at intervals of from 5 minutes to 30 minutes, without the invention being restricted to this cycle time. The amount of backflushed permeate is preferably in the range from 0.1 to 5 l/m² of membrane area, particularly preferably in the range from 0.1 to 2 l/m² of membrane area. The backflushing pressure is preferably in the range from 1 bar to 10 bar.

Depending on the quality of the fermentation output used, it may be necessary to clean the tubular membranes used after a particular time. Cleaning of the tubular membranes can be effected by treating the membranes with a suitable cleaning solution at a temperature of preferably from 20° C. to 100° C., particularly preferably from 40° C. to 80° C. As cleaning solution, it is possible to use acids (mineral acids such as phosphoric acid, nitric acid, or organic acids such as formic acid). The acid concentration is preferably from 1% by weight to 10% by weight. Better cleaning effects are generally achieved by use of alkali metal hydroxide solutions (e.g. sodium hydroxide solution, potassium hydroxide solution). The concentration of alkali metal hydroxide solutions used is preferably in the range from 0.1% by weight to 20% by weight. The addition of oxidizing substances such as hydrogen peroxide, hypochlorite, in particular sodium hydrochlorite, or peracetic acid can significantly improve the cleaning effect. The concentration of the oxidizing substances should be from 0.5% by weight to 10% by weight, in particular from 1% by weight to 5% by weight. Cleaning can particularly preferably be carried out using a mixture of hydrogen peroxide and alkali metal hydroxide solution or hydrogen peroxide and hypochlorite. The cleaning of the membranes is, with the plant switched off, preferably carried out in the installed state in the membrane filtration plant by means of a cleaning-in-place system (CIP system). In the process of the invention, cleaning of the tubular membranes only has to be carried out when an amount of permeate of more than 2000 kg/m² of membrane area has been obtained. The process of the invention thus allows long periods of operation since cleaning of the tubular membranes can be carried out at long intervals.

The process of the invention enables a solution of glucans having a β-1,3-glycosidically linked main chain and side groups which are β-1,6-glycosidically bound thereto, which has a concentration of glucans in the range from ≧3 g/l to ≦30 g/l, particularly preferably in the range from ≧3 g/l to ≦20 g/l, very particularly preferably from ≧5 g/l to ≦15 g/l, and is suitable for tertiary petroleum recovery, to be produced in a simple way.

The yield of schizophyllan, i.e. the amount of schizophyllan which can be isolated after the filtration, based on the amount of schizophyllan in the fermentation broth to be filtered, is preferably in the range from 60% to 80%, particularly preferably from 65% to 75%.

The yield of schizophyllan can be increased further by addition of a diafiltration during or at the end of the filtration.

### EXAMPLES

### Example 1

The crossflow filtration apparatus used is shown in FIG. 2. It comprised a stirred reservoir B1 having a volume of 4 liters, a rotary piston pump P1, the tube heat exchanger W1, the pressure-regulating valve V1 and the filter module F1. The contents of the crossflow filtration plant were brought to 30° C. by means of the heat exchanger W1. A symmetrical tubular membrane from GKN Sinter Metals Filters GmbH, Radevormwald, Germany, model SIKA R3, was used in the filter module. The length of the membrane tube was 430 mm, the internal diameter was 3 mm and the external diameter was 6 mm. The membrane area of the symmetrical tubular membrane which could be utilized for the filtration was 0.00368 m². The wall thickness of the symmetrical tubular membrane was 1.5 mm and the separation limit, determined in accordance with ASTM F 795, was 3 μm. The filter module F1 was backflushed with 6 ml in each case of permeate at intervals of in each case 700 s by means of the valves V3 and V2; the pressure of the compressed air was 8 bar.

Schizophyllum commune was used for the experiments; in fact, the schizophyllan as described in “Udo Rau, Biopolymers, edited by A. Steinbüchel, WILEY-VCH publishers, Volume 6, pages 63 to 79” was produced in a batch fermentation. The fermentation time was 72 hours. The fermentation broth was analyzed and comprised 8.0 g/l of schizophyllan.

1510 g of this fermentation broth (=feed) was introduced into the vessel B1 and circulated at a circulation rate of 75 l/h by means of the pump P1. The flow velocity over the membrane was 2.9 m/s. On opening the permeate discharge valve, the transmembrane pressure was 0.5 bar, and over a period of 5 h it was increased to 3 bar and then maintained at this value for the remainder of the experiment. The permeate was collected and weighed. By means of level regulation, further fermentation broth was introduced into the vessel during the filtration in such a way that the amount in B1 was always kept at 1500 g. The filtration was operated for 34 h and during this time 10 500 g of permeate were collected. The average flux during the filtration was 83.7 kg/h/m². The space velocity over the filter was above 2800 kg/m². The collected permeate was analyzed and a glucan content of 6.5 gram per liter was found; the filtration yield was thus 70%. The permeate was completely clear and did not comprise any cell fragments.

### Example 2

The same crossflow filtration apparatus and the same fermentation broth as in example 1 were used.

1500 g of the fermentation broth was introduced into the vessel B1 and circulated at a circulation rate of 75 l/h by means of the pump P1. The flow velocity over the membrane was 2.9 m/s. On opening the permeate discharge valve, the transmembrane pressure was 0.8 bar, and over a period of 2 h it was increased to 3 bar and then maintained at this value for the remainder of the experiment. The permeate was collected and weighed. By means of level regulation, further fermentation broth was introduced into the vessel during the filtration in such a way that the amount in B1 was always kept at 1500 g. The filtration was operated for 63 h and during this time 10 500 g of permeate were collected. The average flux to this point in time of the filtration was 43.4 kg/h/m². The collected permeate was analyzed and a glucan content of 6.7 gram per liter was found; the filtration yield was thus 74%.

The retentate was then discharged at a ratio of permeate produced to retentate discharged of 7:1. The plant was operated for a further 30 h. During the entire filtration, 14 204 g of permeate and 2032 g of retentate were produced. The average flux during the entire filtration was 41.5 kg/h/m². The space velocity over the filter was above 3800 kg/m2. The permeate was completely clear and did not comprise any cell fragments.

### Example 3

The same crossflow filtration apparatus and the same fermentation broth as in example 1 were used.

1500 g of the fermentation broth was introduced into the vessel B1 and circulated at a circulation rate of 75 l/h by means of the pump P1. The flow velocity over the membrane was 2.9 m/s. On opening the permeate discharge valve, the transmembrane pressure was 0.8 bar, and over a period of 4 h it was increased to 3 bar and then maintained at this value for the remainder of the experiment. The permeate was collected and weighed. By means of level regulation, further fermentation broth was introduced into the vessel during the filtration in such a way that the amount in B1 was always kept at 1500 g. The filtration was operated for 30 h and during this time 10 500 g of permeate were collected. The average flux to this point in time of the filtration was thus 94.7 kg/h/m². The collected permeate was analyzed and a glucan content of 6.2 gram per liter was found; the filtration yield was thus 68%. The retentate was then discharged at a ratio of permeate produced to retentate discharged of 7:1. The plant was operated for a further 25 h. During the entire filtration, 18 284 g of permeate and 2613 g of retentate were produced. The average flux during the entire filtration was 90.2 kg/h/m². The space velocity over the filter was above 2600 kg/m2. The permeate was completely clear and did not comprise any cell fragments.

### Example 4

The same crossflow filtration apparatus and the same fermentation broth as in example 1 were used.

1500 g of the fermentation broth was introduced into the vessel B1 and circulated at a circulation rate of 75 l/h by means of the pump P1. The flow velocity over the membrane was 2.9 m/s. On opening the permeate discharge valve, the transmembrane pressure was 0.8 bar, and over a period of 8 h it was increased to 3 bar and then maintained at this value for the remainder of the experiment. The permeate was collected and weighed. By means of level regulation, further fermentation broth was introduced into the vessel during the filtration in such a way that the amount in B1 was always kept at 1500 g. The filtration was operated for 37 h and during this time 10 500 g of permeate were collected. The average flux to this point in time of the filtration was thus 77.4 kg/h/m². The collected permeate was analyzed and a glucan content of 6.3 gram per liter was found; the filtration yield was thus 68%. The retentate was then discharged at a ratio of permeate produced to retentate discharged of 7:1. The plant was operated for a further 25 h. During the entire filtration, 16 723 g of permeate and 2692 g of retentate were produced. The average flux during the entire filtration was 73.0 kg/h/m². The space velocity over the filter was above 4500 kg/m2. The permeate was completely clear and did not comprise any cell fragments.

### Example 5

The same crossflow filtration apparatus and the same fermentation broth as in example 1 were used.

1500 g of the fermentation broth was introduced into the vessel B1 and circulated at a circulation rate of 75 l/h by means of the pump P1. The flow velocity over the membrane was 2.9 m/s. On opening the permeate discharge valve, the transmembrane pressure was 0.8 bar, and over a period of 16 h it was increased to 3 bar and then maintained at this value for the remainder of the experiment. The permeate was collected and weighed. By means of level regulation, further fermentation broth was introduced into the vessel during the filtration in such a way that the amount in B1 was always kept at 1500 g. The filtration was operated for 39 h and during this time 10 800 g of permeate were collected. The average flux to this point in time of the filtration was thus 75.7 kg/h/m². The collected permeate was analyzed and a glucan content of 6.5 gram per liter was found; the filtration yield was thus 71%. The retentate was then discharged at a ratio of permeate produced to retentate discharged of 7:1. The plant was operated for a further 31 h. During the entire filtration, 16 689 g of permeate and 2388 g of retentate were produced. The average flux during the entire filtration was 64.6 kg/h/m². The space velocity over the filter was above 4500 kg/m2. The permeate was completely clear and did not comprise any cell fragments.

### Example 6

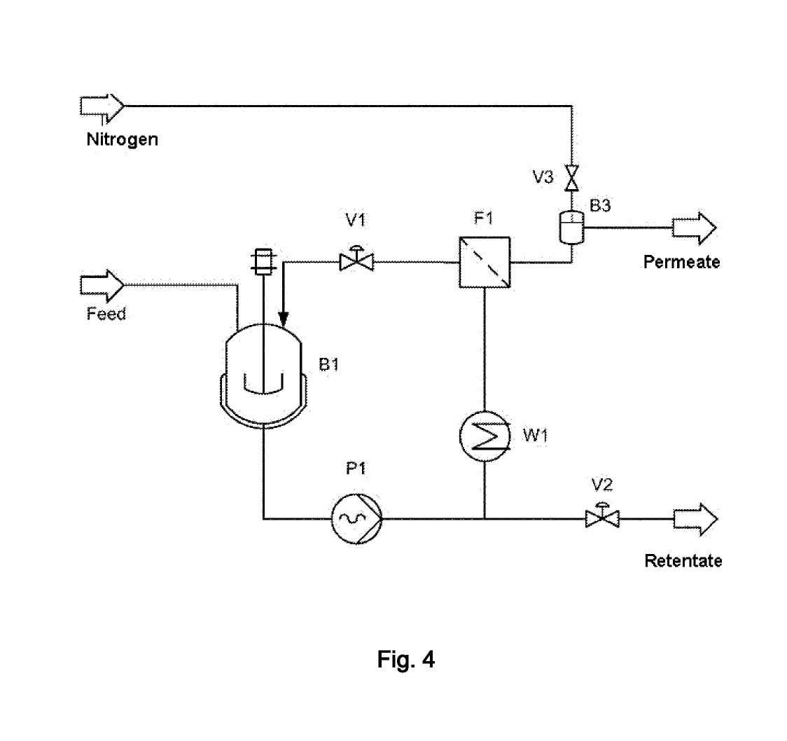

The crossflow filtration apparatus used is shown in FIG. 4. It comprised a stirred double-walled reservoir B1 having a volume of 120 liters, the eccentric screw pump P1, the shell-and-tube heat exchanger W1, the pressure-regulating valve V1 and the filter module F1. The filter module F1 was backflushed using in each case 100 ml permeate at a pressure of 10 bar by means of a backflushing apparatus BF100 from Pall referred to as B3 at intervals of in each case 900 s. The contents of the crossflow filtration plant were cooled to 25° C. by means of the double wall of the vessel B1 and the heat exchanger W1.

Seven symmetrical tubular membranes from GKN Sinter Metals Filters GmbH, Radevormwald, Germany, type SIKA R3, were used in the filter module F1. The length of the membrane tubes was 1000 mm, the internal diameter was 6 mm and the external diameter was 10 mm. The membrane area of the symmetrical tubular membranes which could be utilized for the filtration was 0.132 m². The wall thickness of the symmetrical tubular membrane was 2 mm and the separation limit, determined in accordance with ASTM F 795, was 3 μm.

Schizophyllum commune was used for the experiment; in fact, the schizophyllan as described in “Udo Rau, Biopolymers, Editor A. Steinbüchel, Verlag WILEY-VCH, Volume 6, pages 63 to 79” was produced in a batch fermentation. The fermentation time was 96 hours. The content of schizophyllan in the fermentation broth was 7.6 gram of schizophyllan per liter. 50 kg of this fermentation broth (=feed) was introduced into the vessel B1 (FIG. 4).

The circulation rate of the pump P1 was then set to 2.6 m³/h and a transmembrane pressure of 0.7 bar was applied. The flow velocity over the membrane was 3.6 m/s. The transmembrane pressure was slowly increased and after 18 hours was 1.5 bar. The transmembrane pressure was maintained at this value for the remainder of the experiment. The permeate was collected and weighed. By means of level regulation, further fermentation broth was introduced into the vessel during the filtration in such a way that the amount in B1 was always kept at 50 kg. The filtration was operated for 71 hours and during this time 230.8 kg of permeate were collected. The average flux during the filtration was 24.7 kg/h/m². The space velocity over the filter was 1748 kg/m². The collected permeate was analyzed and a glucan content of 5.3 gram per liter was found; the filtration yield was thus 57%. The permeate was completely clear and did not comprise any cell fragments.

1. A process for separating off an aqueous solution of glucans from an aqueous fermentation broth comprising glucans and biomass in a filtration plant, which comprises at least the following steps:
a) introducing a feed stream comprising the aqueous fermentation broth into the filtration plant,
b) passing the feed stream through at least one symmetrical tubular membrane which has a cylindrical shape and has pores,
c) taking off a permeate stream comprising the aqueous solutions of glucans,
wherein the symmetrical tubular membrane has an internal diameter in the range from ≧2 mm to ≦6 mm.

2. The process according to claim 1, wherein the symmetrical tubular membrane has an internal diameter in the range from ≧3 mm to ≦6 mm.

3. The process according to claim 1, wherein the glucans comprise a main chain composed of β-1,3-glycosidically linked glucose units and side groups which are composed of glucose units and are β-1,6-glycosidically bound to the main chain.

4. The process according to claim 1, wherein the symmetrical tubular membrane has pores having a d90 pore size in the range from ≧4 μm to ≦45 μm determined in accordance with ISO 15901-1.

5. The process according to claim 1, wherein the length of the symmetrical tubular membrane is in the range from ≧0.2 m to ≦1.5 m.

6. The process according to claim 1, wherein the feed stream is conveyed, in step b), at a flow velocity over the membrane in the range from ≧0.5 m/s to ≦5 m/s.

7. The process according to claim 1, wherein the symmetrical tubular membrane has a wall thickness in the range from ≧0.3 mm to ≦3 mm.

8. The process according to claim 1, wherein the symmetrical tubular membrane is made of a material which has a separation limit in the range from ≧0.5 to ≦45 μm, determined in accordance with ASTM F 795.

9. The process according to claim 1, wherein the at least one symmetrical tubular membrane forms, together with from 1 to 15 000 further symmetrical tubular membranes which are arranged parallel to the at least one symmetrical tubular membrane, a membrane module.

10. The process according to claim 9, wherein 2, 3, 4, 5, 6, 7, 8, 9, or 10 membrane modules are arranged in series.

11. The process according to claim 1, wherein the introduction of the feed stream in step a) is carried out continuously.

12. The process according to claim 1, wherein the taking-off of the permeate stream in step c) is carried out continuously.

13. The process according to claim 1, wherein, in step c), the aqueous solution comprises the glucans in a concentration in the range from ≧3 g/l to ≦30 g/l.

14. The process according claim 1, wherein the transmembrane pressure is from 0.1 bar to 10 bar.

15. The process according to claim 1, wherein the transmembrane pressure is set by bringing the transmembrane pressure to the desired value by means of a ramp having a gradient of from 0.05 bar/h to 2 bar/h.
